(19) United States
(12) Patent Application Publication
(10) Pub. No.: US 2005/0083618 A1
(43) Pub. Date: Apr. 21, 2005

(54) ESD protection for integrated circuits

(76) Inventors: Robert M. Steinhoff, Dallas, TX (US); Jonathan S. Brodsky, Richardson, TX (US)

Correspondence Address: TEXAS INSTRUMENTS INCORPORATED, P O BOX 655474, M/S 3999, DALLAS, TX, 75265, US

(21) Appl. No.: 10/690,006

(22) Filed: Oct. 21, 2003

(51) Int. Cl. H02H 9/00

(52) U.S. Cl. 361/56

(57) ABSTRACT

An ESD protection device includes two bipolar npn transistors that are coupled in series for use in clamping applications. The emitter of the first bipolar transistor can be coupled to a protected node and the emitter of the second bipolar transistor can be coupled to a grounded node. The first bipolar transistor and the second bipolar transistor can share a common collector.

### TECHNICAL FIELD

The present invention relates generally to protection devices for integrated circuits, and more particularly to a device for protecting integrated circuits from electrostatic discharge (ESD).

### BACKGROUND OF THE INVENTION

Electrostatic discharge (ESD) is a continuing problem in the design and manufacture of semiconductor devices. Integrated circuits (ICs) can be damaged by ESD events, in which large currents flow through the device. These ESD events can stem from a variety of sources. In one such ESD event, a packaged IC acquires a charge when it is held by a human whose body is electrostatically charged. An ESD event can occur when the IC is inserted into a socket, and one or more of the pins of the IC package touch the grounded contacts of the socket. This type of event is known as a human body model (HBM) ESD event. For example, a charge of about 0.6 μC can be induced on a body capacitance of 150 pF, leading to electrostatic potentials of 4 kV or greater. HBM ESD events can result in a discharge for about 100 nS with peak currents of several amperes to the IC. Another ESD event, which can be caused by metallic objects, is known as a machine model (MM) ESD event. An MM ESD event can be characterized by a greater capacitance and lower internal resistance than the HBM ESD event. The MM ESD event can result in ESD transients with significantly greater rise times than the HBM ESD event. A third ESD event is the charged device model (CDM). The charged device model involves situations where an IC becomes charged and discharges to ground. In this model, the ESD discharge current flows in the opposite direction in the IC than that of the HBM ESD event and the MM ESD event. CDM pulses also typically have very fast rise times compared to the HBM ESD events.

ESD events typically involve discharge of current between one or more pins or pads exposed to the outside of an integrated circuit chip. Such ESD current can flow from the pad to ground through vulnerable circuitry in the IC that may not be designed to carry such currents. Many ESD protection techniques have been employed to mitigate the adverse effects of ESD events in IC devices. Many conventional ESD protection schemes for ICs employ peripheral dedicated circuits to carry the ESD currents from the pin or pad of the device to ground by providing a low, impedance path. In this way, the ESD currents flow through the protection circuitry, rather than through the more susceptible circuits in the chip.

Such protection circuitry is typically connected to I/O and other pins or pads on the IC. Some ESD protection circuits carry ESD currents directly to ground, and others provide the ESD current to the supply rail of the IC for subsequent routing to ground. Rail-based clamping devices can be employed to provide a bypass path from the IC pad to the supply rail (e.g., VDD) of the device. Thereafter, circuitry associated with powering the chip is used to provide such ESD currents to the ground. Local clamps where the ESD currents are provided directly to ground from the pad or pin associated with the ESD event are more common. Individual local clamps are typically provided at each pin on an IC, with the exception of the ground pin or pins.

Many ESD protection devices have been proposed and implemented for protecting ICs from ESD. One commonly used component in an ESD protection device can be a lateral bipolar npn transistor. During an ESD event, the lateral bipolar npn transistor provides a low impedance current path to ground. A bipolar npn transistor can include an emitter, a base, and a collector. The emitter and the base can be connected to the ground. A positive voltage spike at the collector, as caused by an ESD event, applies a reverse bias to the collector/base junction. Avalanching occurs when the electric field in the depletion region exceeds the breakdown field. The avalanche mechanism forms electron/hole pairs. Electrons flow into the collector and holes flow into the p-type base. This hole current flows from the collector junction, generating a positive, i.e., forward, bias, for the emitter/base junction. This emitter forward bias is proportional to the sum of the resistance components in the current path. Those of the electrons injected from the emitter into the base which reach the collector depletion layer will participate in the avalanche mechanism. The electron concentration will be multiplied in accordance with the electric field dependent avalanche multiplication factor M. The resulting reduction of the device impedance is reflected in a “snapback” in the current-voltage characteristics of the device. Snapback, which corresponds to a “turn on” of the bipolar transistor, occurs at the collector voltage with an associated collector current. The field dependence of the avalanche multiplication factor is responsible for the establishment of a new stable current/voltage equilibrium. At high electron injection levels, base conductivity modulation also contributes towards making the device impedance positive again.

One method that is used to improve ESD protection for ICs is biasing the substrate of ESD protection devices on an IC. Such substrate biasing can be effective at improving the response of a bipolar npn transistor that is used to conduct an ESD discharge to ground. Substrate biasing, however, can cause the threshold voltages for devices to change from their nominal values, which may affect device operation. In addition, substrate biasing under steady-state conditions causes heat generation and increases power losses in the IC.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates generally to an ESD protection device and methods for making such a device. The ESD protection device can include two bipolar npn transistors that are coupled in series for use in clamping applications. The emitter of the first bipolar npn transistor can be coupled to a protected node and the emitter of the second bipolar npn transistor can be coupled to a ground node. The first bipolar npn transistor and the second bipolar npn transistor can share a common collector. By sharing a common collector, a high voltage (e.g., greater than about 15 V) ESD protection device can be provided in which the resistance is minimized, for example, to less than about 2 ohms. The resistance is small because the vertical current flow occurs through two series vertical NPN transistors such that no highly-doped DEEPN is required to reach a collector. Additionally, an ESD protection device that includes one common collector can occupy less area (e.g., about two times less) as well as have a reduced parasitic capacitance and leakage compared to two separate bipolar npn transistors, which do not share a common collector.

An ESD protection device with a common collector can be constructed by providing an n-type buried layer in a p-type semiconductor substrate. A first p-type region and a second p-type region can overly the n-type buried layer. An n-well isolation region can isolate and separate the first p-type region and the second p-type region. N⁺ type regions can be formed in each p-type region.

The first n⁺ type region can function as the emitter of the first bipolar npn transistor, and the second n⁺ type region can function as the emitter of the second bipolar npn transistor. The first p-type region can function as the base region of the first bipolar npn transistor, and the second p-type region can function as the base region of the second bipolar npn transistor. The n-type buried layer can function as the collector for both the first bipolar npn transistor and the second bipolar npn transistor.

### BRIEF DESCRIPTION OF THE DRAWINGS

The foregoing and other aspects of the present invention will become apparent to those skilled in the art to which the present invention relates upon reading the following description with reference to the accompanying drawings.

FIG. 1 illustrates a schematic circuit diagram of an ESD protection device in accordance with one aspect of the present invention.

FIG. 2 illustrates a schematic circuit diagram of an ESD protection device in accordance with another aspect of the present invention.

FIG. 3 illustrates a schematic cross-sectional view of part of the ESD protection device of FIG. 1 in accordance with one aspect of the invention.

FIG. 4 illustrates a schematic top plan view of part of the ESD protection device of FIG. 3.

FIG. 5 illustrates a schematic top plan view of part of the ESD protection device of FIG. 1 in accordance with another aspect of the invention.

FIG. 6 illustrates a schematic cross-sectional view of a substrate in accordance with an aspect of the present invention.

FIG. 7 illustrates a schematic cross-sectional view of the substrate of FIG. 6 undergoing implantation of an n-type dopant to form an n-type buried layer in accordance with an aspect of the present invention.

FIG. 8 illustrates a schematic cross-sectional view of the structure of FIG. 7 after a p-epitaxial layer is formed over the substrate in accordance with an aspect of the present invention.

FIG. 9 illustrates a schematic cross-sectional view of the structure of FIG. 8 undergoing implantation of an n-type dopant to form an n-well isolation region in accordance with an aspect of the present invention.

FIG. 10 illustrates a schematic cross-sectional view of the structure of FIG. 9 undergoing implantation of an n⁺ type dopant to form a first n⁺ type emitter region and a second n⁺ type emitter region accordance with an aspect of the present invention.

FIG. 11 illustrates a schematic cross-sectional view of the structure of FIG. 10 undergoing implantation of an p⁺ type dopant to form a first p⁺ type emitter region and a second p⁺ type emitter region accordance with an aspect of the present invention.

### DETAILED DESCRIPTION

The present invention relates generally to an ESD protection device and methods for making such a device. The ESD protection device includes two bipolar npn transistors that are coupled in series for use in clamping applications. The first bipolar npn transistor and the second bipolar npn transistor can share a common collector. By sharing a common collector, a high voltage (e.g., greater than about 15 volts) ESD protection device can be provided in which the resistance is minimized, for example, to less than about 2 ohms. Additionally, an ESD protection device with a common collector can occupy less area (e.g., about two times less) as well as have a reduced parasitic capacitance and leakage compared to two separate bipolar npn transistors, which do not share a common collector.

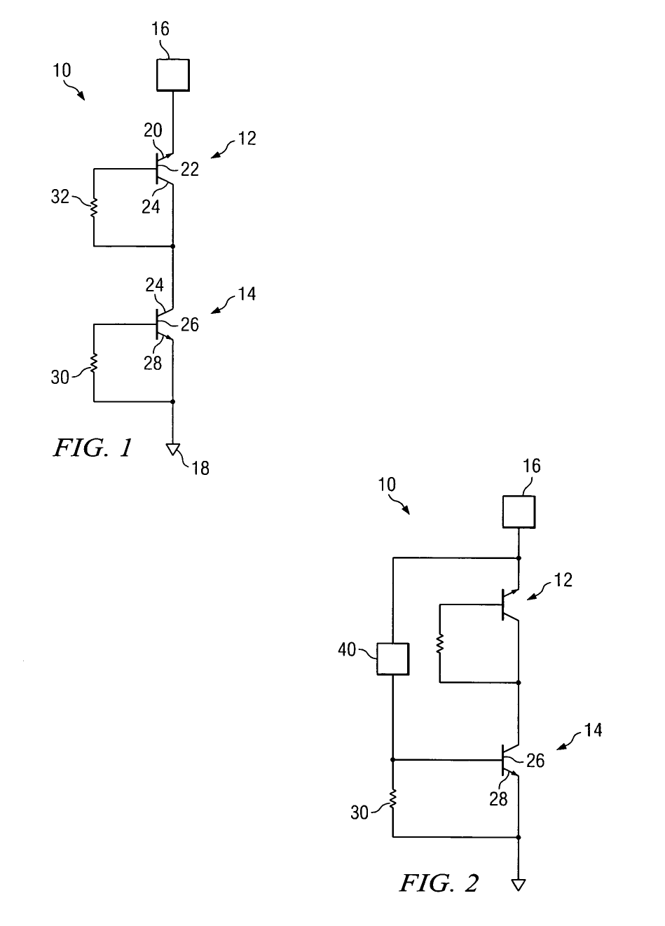

FIG. 1 illustrates a schematic circuit design of an ESD protection device 10 in accordance with one aspect of the present invention. The ESD protection device 10 includes a first bipolar npn transistor 12 and a second bipolar npn transistor 14 coupled in series between a protected node 16 and a ground node 18. The protected node 16 can comprise an input terminal configured to receive an ESD event signal. The protected node 16 can be, for example, a protected pin of an I/O pad or any other node configured to receive an ESD event or that might experience an ESD event.

The first bipolar npn transistor 12 includes an emitter 20, a base 22, and a collector 24, and the second bipolar npn transistor 14 includes an emitter 28, a base 26, and a collector 24. The emitter 28 of the first bipolar transistor 12 can be electrically coupled to the protected node 16 and can, therefore, be configured to receive the ESD event signal from the protected node 16. The emitter 18 of the second bipolar npn transistor 14 can be electrically coupled to the ground node 18. The emitter 28 of the second bipolar npn transistor 14 can also be electrically coupled to the base 26 of the second bipolar npn transistor 14 through a resistor 30. The resistor 30 can be external to the ESD protection device 10 (e.g., a thin film layer of polysilicon on a semiconductor substrate) or a parasitic resistance built into the second bipolar npn transistor 14.

The first bipolar transistor 12 and the second bipolar transistor 14 can share a common collector 24. By sharing a common collector 24, the size (i.e., area) of the ESD protection device 10 can be reduced compared to ESD protection devices that have separate collectors. Reduction in area minimizes the resistance, parasitic capacitance, and leakage of the ESD protection device 10.

The collector 24 can be electrically coupled to the base 22 of the first bipolar npn transistor 22 through a resistor 32. The resistor 32 can be external to the ESD protection device 10 (e.g., a thin film layer of polysilicon on a semiconductor substrate) or a parasitic resistance built into the first bipolar npn transistor 12.

Operation of the ESD protection device 10 can occur in response to an ESD event, such as a voltage spike at the protected node 16. A positive voltage spike (e.g., about 30V), as caused by the ESD event, applies a reverse bias to the emitter/base junction of the first bipolar npn transistor 12 and the collector/base junction of the second bipolar npn transistor 14. The emitter/base voltage of the first bipolar npn transistor 12 rises until it reaches an emitter/base junction breakdown voltage, i.e., BV_{eb} (e.g., about 10V). Similarly, the collector/base voltage of the second bipolar npn transistor 14 rises until it reaches the collector/base breakdown voltage, i.e., BV_{cb} (e.g., about 20V). It will be appreciated by one skilled in the art that that the breakdown voltage of the first bipolar npn transistor 12 and the second bipolar npn transistor 14 can be dependent upon the processing of the first bipolar npn transistor 12 and the second bipolar npn transistor 14.

Impact ionization can occur in the emitter/base junction and the collector/base junction. When the electric field exceeds the breakdown field for the first bipolar npn transistor 12 and the second bipolar npn transistor 14, avalanching occurs in the first bipolar npn transistor 12 and the second bipolar npn transistor 14. Electrons flow into the emitter 20 of the first bipolar npn transistor 12 and the collector 24 of the second bipolar npn transistor 14. Holes flow into the base 22 of the first bipolar npn transistor 12 and the base 26 of the second bipolar npn transistor 14. The hole current flow into the bases 22 and 26 generates a negative base current and a positive, i.e., forward, bias for the collector/base junction of the first bipolar npn transistor 12 and the emitter/base junction of the second bipolar npn transistor 14. The generated hole current, I_{B}, required to forward bias the collector/base junction of the first bipolar npn transistor 12 and the second bipolar npn transistor 14 is dependent on the internal base resistance as well as any external resistance, such as provided by an external resistor, if used. The I_{B} current of the first bipolar npn transistor 12 and the second bipolar npn transistor 14 turns on the first bipolar npn transistor 12 and the second bipolar npn transistor 14.

Once the first bipolar npn transistor 12 and the second bipolar npn transistor 14 turn on, the electron current reaching the reverse biased emitter/base junction and the collector/base junction increases the number of generated electron hole pairs. The resulting reduction of the device impedance is reflected in a decrease (i.e., snapback) of the V_{eb} of the first bipolar npn transistor 12 (e.g., a decrease from about 10V to a snapback holding voltage of about 7V) and the V_{cb} of the second bipolar npn transistor 14 (e.g., a decrease from about 20V to a snapback holding voltage of about 15V).

The trigger voltage of the ESD protection device 10 (e.g., about 30V) can be the sum of the trigger voltage of the first bipolar npn transistor 12 (e.g., about 10V) and the trigger voltage of the second bipolar transistor 14 (e.g., about 10V). The snapback holding voltage of the ESD protection device 10 (e.g., about 22V) can be the sum of the snapback holding voltage of the first bipolar npn transistor 12 (e.g., about 7V) and the snapback holding voltage of the second bipolar npn transistor 14 (e.g., about 15V).

Optionally, the ESD protection device 10 can biased to reduce the trigger voltage of the ESD protection device 10. For example, as illustrated in FIG. 2, the ESD protection device 10 can include a clamp 40 that is electrically coupled between the protected node 16 and the base 26 of the second bipolar npn transistor 14. The clamp 40 can include any two-terminal circuit that breaks down before the first bipolar npn transistor 12 and/or the second bipolar npn transistor 14 to reduce the overall trigger voltage of the ESD protection device 10. Examples of two-terminal circuits that can be used as the clamp 40 include an avalanche diode, such as an n-well, p-moat diode, a bipolar npn transistor, a bipolar pnp transistor, an NMOS transistor, and a PMOS transistor. It will be appreciated by one skilled in the art that other two-terminal circuits, which break down before the first bipolar npn transistor 12 and/or the second bipolar npn transistor 14 can also be used.

During operation of an ESD protection device 10 that is biased to reduce the trigger voltage, current from the clamp 40 passes through the resistor 30 and increases V_{be} of the second bipolar npn transistor 14. As V_{be} becomes more positive, electrons entering the base 26 from the emitter 28 can contribute to the avalanche generation at the collector/base junction of the second bipolar npn transistor 14. Thus, the voltage required for a given I_{B} is lower and, since V_{be} is already positive, the I_{B} required to fully turn on the second bipolar npn transistor 14 is reduced. Therefore, the trigger voltage for the ESD protection device 10 is also reduced.

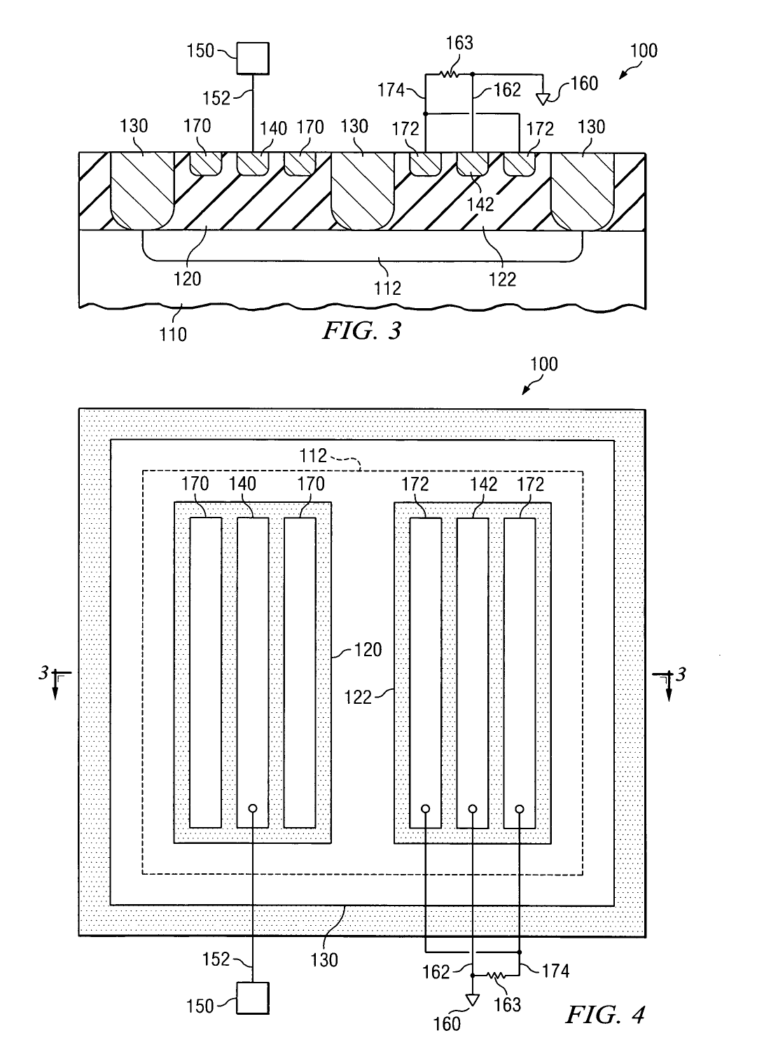

FIG. 3 illustrates a cross-section of a portion of an implementation of the circuit for the ESD protection device in accordance with FIG. 1. The ESD protection device 100 can be constructed from a substrate 110 having embedded therein an n-type buried layer 112. The substrate material 110 can be a p-type semiconductor material and the n-type buried layer 112 can be formed in the p-type substrate 110 by implanting an n-type dopant, such as arsenic, in the p-type substrate material 110. The n-type buried layer 112 functions as the common collector 24 (FIG. 1) of the first bipolar npn transistor 12 and the second bipolar npn transistor 14.

The ESD protection device 100 can include a first p-type region 120 and a second p-type region 122 that overly at least a portion of the n-buried layer 112. The first p-type region 120 functions as the base 22 (FIG. 1) of the first bipolar npn transistor 12, and the second p-type region 122 functions as the base 26 of the second bipolar npn junction transistor 14. FIG. 4, which is a plan view of FIG. 3, shows that the first p-type region 120 and the second p-type region 122 can be spaced apart and can extend substantially parallel to one another. The first p-type region 120 and the second p-type region 122 can be formed respectively from a p-type epitaxial layer or by selectively implanting a dose of a p-type dopant, such a boron (B) or an any other p-type dopant into an n-well region.

Referring to FIG. 3 and FIG. 4, an n-well isolation region 130 surrounds the first and second p-type regions 120 and 122 and sufficiently overlaps the n-type buried layer 112 so that the first and second p-type regions 120 and 122 are isolated from one other as well as from the p-type substrate 110. In order to create effective isolation of the first and second p-type regions 120 and 122, the n-well isolation region 130 contains essentially no gaps between the n-well isolation region 130 and the n-type buried layer 112. The n-well isolation region 130 can be formed by selectively implanting an n-type dopant, such as phosphorous (P), in a p-type epitaxial layer or the p-type substrate.

The ESD protection device 100 further includes a first n⁺ type region 140 and a second n⁺ type region 142 that can be provided, respectively, in the first p-type region 120 and the second p-type region 122. The first n⁺ type region 140 functions as the emitter 20 (FIG. 1) of the first bipolar npn transistor 12, and the second n⁺ type region 142 functions as the emitter 28 of the second bipolar npn transistor 14. The first n⁺ type region 140 and the second n⁺ type region 142 can extend within the first p-type region 120 and the second p-type region 122, respectively, substantially the length of the first p-type region 120 and the second p-type region 122. The first n⁺ type region 140 can be electrically coupled to the protected node 150 through a lead 152. The second n⁺ type region 142 can be electrically coupled to a grounded node 160 through a lead 162.

Optionally, where the second resistor 163 is an external resistor, the second n⁺ type region 142 can also be electrically coupled to the second p-type region 122 through such external resistor 163. The external resistor 163 can comprise a thin film layer (e.g., polysilicon) on the surface of the ESD protection device 100 or a channel formed in the semiconductor substrate. The first n⁺ type region 140 and the second n⁺ type region 142 can be formed, respectively, by selectively implanting a high dose of a n⁺ type dopant, such a phosphorous (P) or any other n⁺ type dopant into the first p-type region 120 and the second p-type base region 122.

P⁺ contact regions 170 and 172 can also be provided in the p-type regions 120 and 122. The p⁺ contact regions 170 and 172 can extend essentially parallel the n⁺ type regions 140 and 142 substantially the length the n⁺ type regions 140 and 143 within the p-type regions 120 and 122 so that the p⁺ contact regions 170 and 172 essentially straddle the n⁺ type regions 140 and 142. The p⁺ contact regions 172 straddling the second n⁺ type region 142 can be electrically coupled to the grounded node 160 through a lead line 174 and resistor 163.

Optionally, where the first resistor (not shown) is an external resistor, the p⁺ contact regions 170 straddling the first n+ type region 140 can be electrically coupled to the n-buried layer 112 through an external resistor. The external resistor can comprise a thin film layer (e.g., polysilicon) on the surface of the ESD protection device 100 or a channel formed in the semiconductor substrate. The p⁺ contact regions 170 and 172 can be formed, respectively, by selectively implanting a high dose of a p⁺ type dopants, such as boron (B) or any other p⁺ type dopant into the first p-type region 120 and the second p-type region 122.

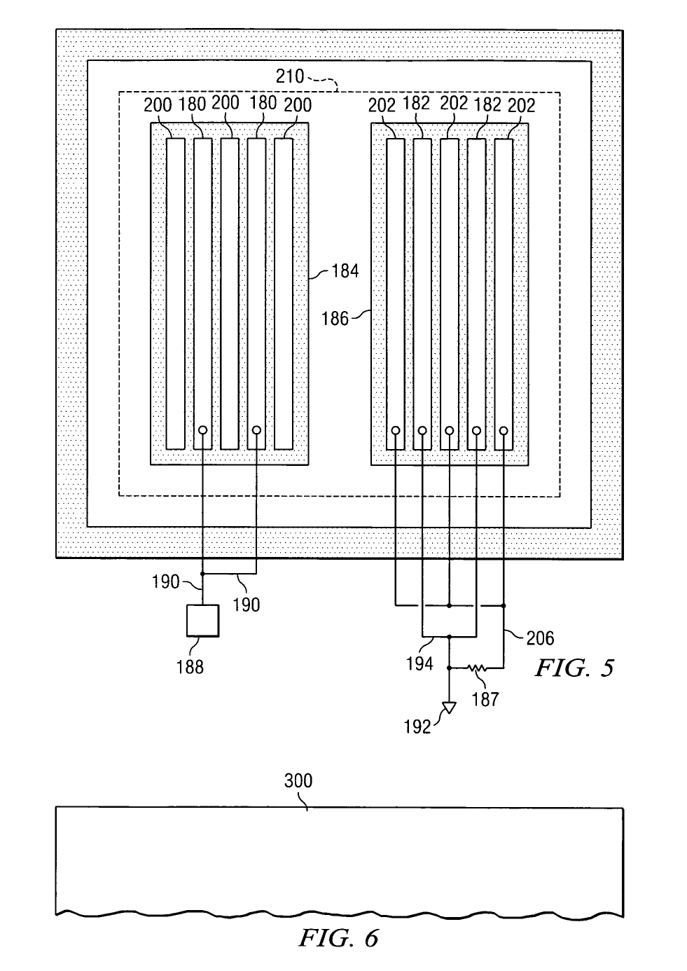

Optionally, as illustrated in FIG. 5, at least two n⁺ type regions 180 and 182 can be provided, respectively, in p-type regions 184 and 186. The two n⁺ type regions 180 and 182 in p-type regions 184 and 186 can extend substantially parallel to one another essentially the length of the p-type regions 184 and 186. The n⁺ type regions 180 in the first p-type region 184 can be electrically coupled to the protected node 188 through leads 190. The n⁺ type regions 182 in the second p-type region 186 can be electrically coupled to a grounded node 192 through lead 194. Optionally, where the second resistor 30 (FIG. 1) is an external resistor, the second n⁺ type regions 182 can also be electrically coupled to the second p-type region 186 through an external resistor 187.

P⁺ contact regions 200 and 202 can also be provided, respectively, in p-type regions 184 and 186. The p⁺ contact regions 200 and 202 can essentially straddle the n⁺ type regions 180 and 182. The p⁺ contact regions 202 straddling the n⁺ type regions 182 in the second p-type region 186 can be electrically coupled to the grounded node 192 through lead line 206 and resistor 187. Optionally (not shown), where the first resistor 32 (FIG. 1) is an external resistor, the p⁺ contact regions 200 straddling the first n⁺ type regions 180 can be electrically coupled to the n-buried layer 210 through an external resistor.

By providing at least two n⁺ type regions 180 and 182 in p-type regions 184 and 186 and straddling the n⁺ type regions 180 and 182 with p⁺ contact regions 200 and 202, the base potential of the ESD protection device can be kept substantially more uniform than if only one n⁺ type region and one p⁺ contact region is provided in each p-base region. A more uniform base potential results a more uniform triggering of the ESD protection device and more uniform current through the ESD protection device.

FIGS. 6-11 illustrate a methodology of fabricating a part of the ESD protection in accordance with an aspect of the present invention. FIG. 6 illustrates a p-type substrate layer 300 that can be formed from a semiconductor material, such as silicon or polysilicon. The substrate layer 300, however, could be formed from any material, such as gallium arsenide, germanium, silicon-germanium, epitaxial formations, silicon carbide, indium phosphide, silicon-on-insulator substrates (SOI), strained Si substrates, and/or other semiconductor substrate materials.

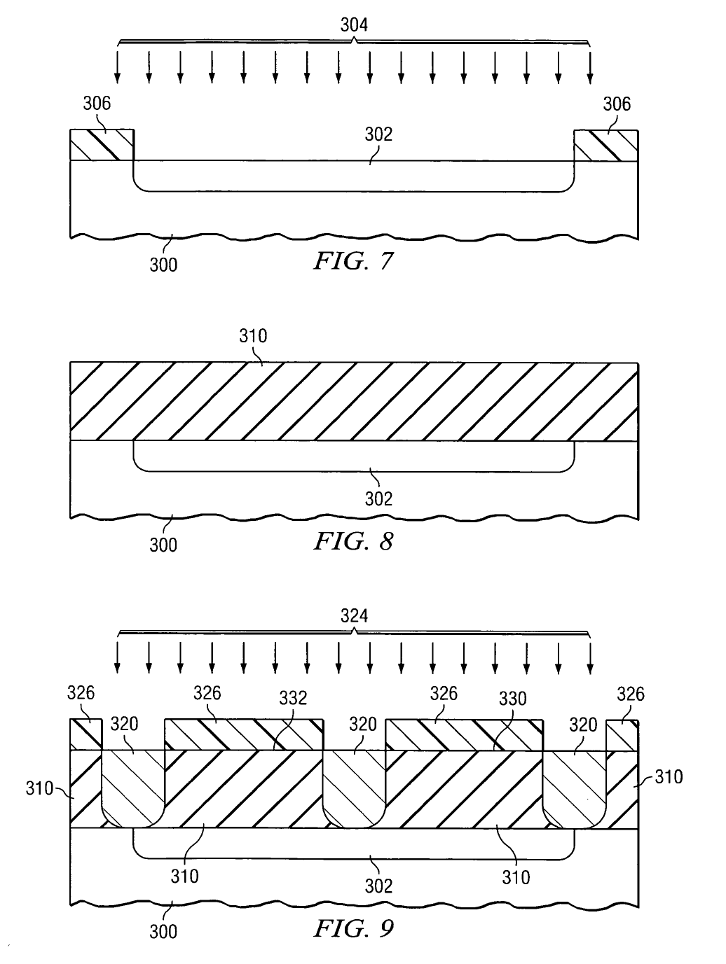

FIG. 7 illustrates an n-type buried layer 302 being formed in the p-type substrate 300 by implanting an n-type dopant 304, such as phosphorous and/or arsenic, into the p-type substrate layer 300. During formation of the n-type buried layer 302 in the p-type substrate layer 300, a patterned photoresist layer 306 can be provided on the substrate 300 to form a mask, which defines the area of the n-type buried layer 302 during implantation of the n-type dopant 304.

The implantation of the n-type dopant 304 can be performed, for example, using an ion implanter that accelerates the dopant ions (e.g., As) at a high energy (e.g., about 150 to about 250 KeV). The dose and energy used during implantation of the n-type dopant can vary depending on the particular dopant used. After ion implantation, the patterned photoresist 306 can be stripped off the substrate 300 (e.g., Ultra-Violet (UV)/Ozone (O₃)/Sulfuric Acid (H₂SO₄)) and cleaned by wet chemical cleanup processes. Those skilled in the art would be familiar with a variety of different cleanup procedures that can be employed to clean the structure.

FIG. 8 illustrates the p-type substrate 300 after a p-epitaxial layer 310 has been formed over the surface of the p-type substrate 300 and n-type buried layer 302. The p-epitaxial layer 310 can have a thickness of about 5 μm to about 10 μm and can be formed using any suitable technique, including chemical vapor deposition (CVD) techniques, such as low pressure CVD (LPCVD), plasma enhanced CVD (PECVD), and rapid thermal CVD (RTCVD). The p-epitaxial layer 310 can comprise the same material as the p-type substrate 300 (e.g., Si layer on Si substrate) or can comprise a different material. During the epitaxial growth process, in situ p-type doping can be employed to provide the epitaxial layer with a p-type dopant. It will be appreciated, that other types of epitaxy formation techniques, such as vapor phase epitaxy (VPE) and molecular beam epitaxy (MBE) can also be employed, to form the p-epitaxial layer 310.

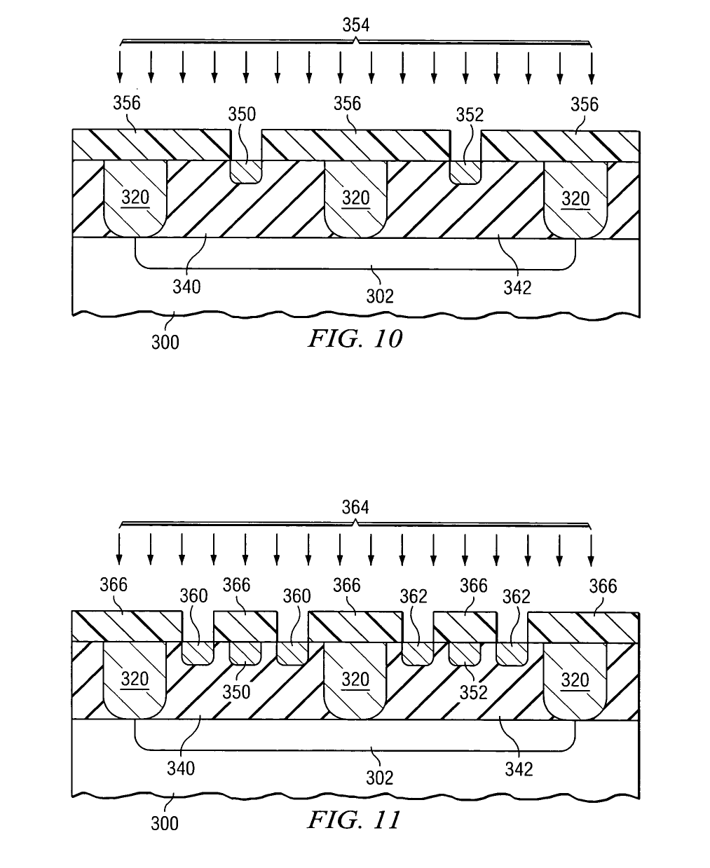

FIG. 9 illustrates an n-well isolation region 320 being formed in the p-epitaxial layer 310 by selectively implanting an n-type dopant 324, such as phosphorous and/or arsenic, into the p-epitaxial layer 310. During formation of the n-well isolation region 320 in the p-epitaxial layer 310, a patterned photoresist layer 326 can be provided on the p-epitaxial layer 310, which masks off a first area 330 and a second area 332 of the p-epitaxial layer 310 overlying the n-buried layer 302. Masking off the first area 330 and second area 332 during implantation creates a first p-type region 340 (FIG. 10) and a second p-type region 342, which are isolated by the n-well isolation region 320.

The implantation of the n-type dopant 324 can be performed, for example, using an ion implanter that accelerates the dopant ions (e.g., P) at a high energy (e.g., about 150 to about 250 keV). The dose and energy used during implantation of the n-type dopant can vary depending on the particular dopant used and device dimensions. After ion implantation, the patterned photoresist 326 can be stripped off the structure (e.g., Ultra-Violet (UV)/Ozone (O₃)/Sulfuric Acid (H₂SO₄)) and the structure can be cleaned by wet chemical cleanup processes. Those skilled in the art would be familiar with a variety of different cleanup procedures that can be employed to clean the structure.

FIG. 10 illustrates a first n⁺ type region 350 and a second n⁺ type region 352 being formed in the first p-type region 340 and the second p-type region 342 by selectively implanting a high dose of an n⁺ type dopant 354, such as phosphorous and/or arsenic, into the first p-type region 340 and the second p-type region 342. During formation of the first n⁺ type region 350 and the second n⁺ type region 352, respectively, in the first p-type region 340 and the second p-type region 342, a patterned photoresist layer 356 can be provided on the p-type regions 340 and 342 to form a mask, which defines the area of the first n⁺ type region 350 and the second n⁺ type region 352 during implantation of the n⁺ type dopant 3544.

The implantation of the n⁺ type dopant 354 can be performed, for example, using an ion implanter that accelerates the n⁺ dopant ions (e.g., P) at a medium to high energy. The dose and energy used during implantation of the n-type dopant can vary depending on the particular dopant used. After ion implantation, the patterned photoresist 356 can be stripped off the structure (e.g., Ultra-Violet (UV)/Ozone (O₃)/Sulfuric Acid (H₂SO₄)) and the structure can be cleaned by wet chemical cleanup processes.

FIG. 11 illustrates p⁺ contact regions 360 and 362 being formed in the p-type regions 340 and 342 by selectively implanting a p+ type dopant 364, such as boron (B), into the p-type regions 340 and 342. During formation of the p⁺ contact regions 360 and 362 in the p-type region 340 and 342, a patterned photoresist layer 366 can be provided on the p-type regions 340 and 342 to form a mask, which defines the area of the p⁺ contact regions 360 and 362 during implantation of the p⁺ type dopant 364.

The implantation of the p⁺ type dopant 364 can be performed, for example, using an ion implanter that accelerates the p⁺ type dopant ions (e.g., B) at a medium to high energy. The dose and energy used during implantation of the p⁺ type dopant 364 can vary depending on the particular dopant used. After ion implantation, the patterned photoresist 106 can be stripped off the structure (e.g., Ultra-Violet (UV)/Ozone (O₃)/Sulfuric Acid (H₂SO₄)) and the structure can be cleaned by wet chemical cleanup processes.

Following formation of the n⁺ type regions 350 and 352 and the p⁺ type contact regions 360 and 362 additional processing steps can be performed to complete the ESD protection device. For example, leads can be connected to the contacts and external resistors can be formed on or in the p-type substrate 300.

Those skilled in the art will also understand and appreciate that variations in the processing operations can be utilized in the formation of an ESD protection device in accordance with an aspect of the present invention. For example, it is to be appreciated that a p-epitaxial layer need not be grown on the p-type semiconductor substrate after formation of the n-type buried layer. The n-well isolation region can be formed in the p-type substrate after formation of the n-type buried layer. A p-type dopant can then be selectively implanted in the n-well isolation region to form a first p-type base region and a second p-type base region. Moreover, it is appreciated that additional ESD protection devices can be formed on the substrate and these additional ESD protection devices can have multiple emitter fingers.

What has been described above includes examples and implementations of the present invention. Because it is not possible to describe every conceivable combination of components, circuitry or methodologies for purposes of describing the present invention, one of ordinary skill in the art will recognize that many further combinations and permutations of the present invention are possible. Accordingly, the present invention is intended to embrace all such alterations, modifications and variations that fall within the spirit and scope of the appended claims.

1. An electrostatic discharge protection device comprising:
a first bipolar transistor and a second bipolar transistor coupled in series, and
an emitter of the first bipolar transistor being coupled to a protected node and an emitter of the second bipolar transistor being coupled to a grounded node, the first bipolar transistor and the second bipolar transistor having a common collector.

2. The electrostatic discharge protection device of claim 1, the first bipolar transistor and the second bipolar transistor being npn transistors.

3. The electrostatic discharge protection device of claim 1 further comprising a clamp electrically coupled between the protected node and a base of the second bipolar transistor.

4. The electrostatic discharge protection device of claim 3, the clamp comprising a two-terminal circuit.

5. The electrostatic discharge protection device of claim 4, the two-terminal circuit being configured to breakdown before the first and second bipolar transistor break down to reduce the overall trigger voltage of electrostatic discharge protection device.

6. The electrostatic discharge protection device of claim 4, the two-terminal circuit comprising at least one of an n-moat-p-well diode, a bipolar npn transistor, a bipolar pnp transistor, an NMOS transistor, and a PMOS transistor.

7. The electrostatic discharge protection device of claim 2, the common collector being formed by a first n-type region.

8. The electrostatic discharge protection device of claim 2, the first n-type region being coupled to a first p-type region and a second p-type region, the first p-type region forming a base of the first bipolar transistor, the second p-type region forming a base of the second bipolar transistor.

9. The electrostatic discharge protection device of claim 8, comprising an n-type doped isolation region that substantially surrounds and separates the first p-type region and the second p-type region.

10. The electrostatic discharge protection device of claim 9, comprising a second n-type region and a third n-type region, the second n-type region being formed within the first p-type region and separated from the first n-type region, the third n-type region being formed within the second p-type region and separated from the first n-type, the second n-type region forming the emitter of the first bipolar transistor and the third n-type region forming the emitter of the second bipolar transistor.

11. An electrostatic discharge protection device comprising:
a p-type semiconductor substrate;
an n-type buried layer provided in the p-type semiconductor substrate;
a first p-type region and a second p-type region overlying the n-type buried layer, the first p-type region and the second p-type region being separated from one another;
a first n⁺ type region provided in the first p-type region;
a second n⁺ type region provided in the second p-type region; and
the first n⁺ type region, the first p-type region, and the n-type buried layer forming a first bipolar npn transistor, the second n⁺ type region, the second p-type region, and n-type buried layer forming a second bipolar npn transistor, the first bipolar npn transistor and the second bipolar npn transistor including a common collector.

12. The electrostatic discharge protection device of claim 11, the first bipolar npn transistor and the second bipolar npn transistor being coupled in series.

13. The electrostatic discharge device of claim 12, further comprising an n-well isolation region that separates the first p-type region and the second p-type region.

14. The electrostatic discharge device of claim 11, the first n⁺ type region functioning as an emitter of the first bipolar npn transistor, and the second n⁺ type region functioning as an emitter of the second bipolar npn transistor.

15. The electrostatic discharge device of claim 14, the first p-type region functioning as a base region of the first bipolar npn transistor, and the second p-type region functioning as a base region of the second bipolar npn transistor.

16. The electrostatic discharge device of claim 15, the n-type buried layer functioning as a common collector for both the first bipolar npn transistor and the second bipolar npn transistor.

17. The electrostatic discharge protection device of claim 16, further comprising a two-terminal circuit electrically coupled between a protected node and the base of the second bipolar transistor, the two terminal circuit configured to break down before the first and second bipolar transistor break down to reduce the trigger voltage of electrostatic discharge protection device.

18. A method for fabrication of an ESD protection device, the method comprising:
providing an n-type buried layer in a p-type semiconductor substrate;
forming a first p-type region and a second p-type region overlying the n-type buried layer;
forming a first p-type region and a second p-type region overlying the n-type buried layer, the first p-type region and the second p-type region being separated from one another;
forming a first n⁺ type region in the first p-type region;
forming a second n⁺ type region in the second p-type region; the first n⁺ type region, the first p-type region, and the n-type buried layer defining a first bipolar npn transistor, the second n⁺ type region, the second p-type region, and n-type buried layer defining a second bipolar npn transistor.

19. The method of claim 18, further comprising forming an n-well isolation region that separates the first p-type region and the second p-type region.

20. The method of claim 19, the first n⁺ type region functioning as an emitter of the first bipolar npn transistor, the second n⁺ type region functioning as an emitter of the second bipolar npn transistor, the first p-type region functioning as a base region of the first bipolar npn transistor, the second p-type region functioning as a base region of the second bipolar npn transistor, and the n-type buried layer functioning as a collector for both the first bipolar npn transistor and the second bipolar npn transistor.
